(19) United States
(12) Patent Application Publication
(10) Pub. No.: US 2026/0072912 A1
(43) Pub. Date: Mar. 12, 2026

(54) SEMANTIC SEARCH IN HIGH-DIMENSIONAL SPACES USING EUCLIDEAN DISTANCE AND CLUSTER-BASED OPTIMIZATION

(71) Applicant: AIceberg.inc, New York, NY (US)

(72) Inventors: Alexander Schlager, Gladstone, NJ (US); Amaury Lendasse, Katy, TX (US); Peggy Lindner, Sugar Land, TX (US); Renjie Hu, Missouri City, TX (US)

(21) Appl. No.: 19/306,909

(22) Filed: Aug. 21, 2025

Related U.S. Application Data
(60) Provisional application No. 63/693,495, filed on Sep. 11, 2024.

(51) Int. Cl. G06F 16/2453; G06F 16/2458

(52) U.S. Cl. CPC G06F 16/24542; G06F 16/2474

(57) ABSTRACT

Computer-implemented systems and methods implement semantic search in high-dimensional vector spaces, specifically tailored for use with large language models (LLMs). In particular, clustering is combined with Euclidean distance measurements to facilitate real-time vector searches. By implementing clustering, the invention reduces the computational complexity and costs associated with Euclidean distance calculations, which are typically more resource-intensive than other methods such as cosine similarity. This reduction is achieved by limiting the scope of distance calculations to within clusters, thereby avoiding the inefficiencies and diminished accuracy otherwise encountered by existing systems when using Euclidean distance in high-dimensional spaces. As a result, the invention retains the benefits of Euclidean distance, such as its superior granularity and precision in measuring semantic relevance, without succumbing to the usual drawbacks of high computational demands and poor scalability.

### CROSS-REFERENCE TO RELATED APPLICATIONS

This application claims priority to U.S. Prov. Pat. App. No. 63/693,495, entitled “Semantic Search in High-Dimensional Spaces Using Euclidean Distance and Cluster-Based Optimization,” filed on Sep. 11, 2024, which is hereby incorporated by reference herein.

### BACKGROUND

Semantic searches across extensive datasets are now in widespread use, such as in the realm of large language models (LLMs), in order to generate relevant and contextually appropriate responses to prompts provided to those models. However, traditional methods of integrating and searching through high-dimensional vector spaces present several significant challenges that impact the efficiency, accuracy, and overall utility of language models in practical applications, particularly in terms of the quality and relevance of the contextual information provided to those models.

For example, high-dimensional vector spaces, which are typically used to represent text data in a form that LLMs can process, require complex and computationally intensive methods to search and retrieve information. Traditional distance metrics, such as Euclidean distance, while theoretically sound, become less effective and more resource-intensive as the dimensionality of the data increases. This computational burden is a major barrier, especially for applications requiring real-time or near-real-time responses.

As the dimensionality of the data (the representation of data via embeddings) increases, the effectiveness of traditional distance metrics such as Euclidean distance tends to diminish. In high-dimensional spaces, distances between points can become uniformly large or indistinct, which can lead to a decrease in the ability to discern truly relevant results from less relevant ones. This phenomenon, known as the “curse of dimensionality,” severely limits the practical usability of semantic searches in such environments.

As a result, cosine similarity is the most common distance metric in use to determine the relevance of a given point to a user's query, primarily due to its high speed and low cost. Despite its advantages in speed and cost, cosine similarity is not without its drawbacks. It can sometimes fail to capture the true semantic similarity between complex text data points, particularly in nuanced or context-heavy queries. Moreover, it may not perform well in distinguishing between closely related but distinct contexts, leading to less accurate or relevant results. Yet, due to its efficiency in computation, systems continue to rely on cosine similarity, often at the expense of precision and depth in semantic understanding.

Furthermore, enterprises often hesitate to fine-tune large language models with their proprietary data due to the risk of exposing sensitive information. The process of fine-tuning can potentially allow external parties to extract confidential information through sophisticated query techniques or prompt engineering. This security concern restricts organizations from leveraging their own data to enhance the model's performance, leading to a reliance on generic models that may not offer the best results for specific enterprise needs.

In applications where LLMs are used, the speed of retrieving and processing information directly impacts the user experience. Delays in response times, even if minor, can disrupt the interaction flow, making the technology seem less efficient and reducing user satisfaction and engagement.

As enterprises scale up their use of LLMs, the volume of data to be processed and searched increases exponentially. Existing methods may not scale efficiently, leading to increased costs and reduced performance, which can hinder the broader adoption of LLM technologies in large-scale enterprise environments.

By addressing these challenges, any improvements in the field would not only enhance the operational efficiency and accuracy of semantic searches in high-dimensional spaces but also bolster data security, improve user engagement, and facilitate the scalable use of LLMs across various industries. The benefits of solving these problems are therefore substantial, promising to significantly improve how enterprises interact with and utilize large language models for their specific needs.

### SUMMARY

Embodiments of the present invention relate to advancements in the field of information retrieval and language processing, particularly focusing on enhancing the efficiency and accuracy of semantic searches which, among other areas of application, are used for content that will be used as context by large language models (LLMs) using high-dimensional vector spaces. Embodiments of the present invention introduce a novel method for organizing and searching vector spaces that significantly improves upon traditional techniques, which are often limited by computational inefficiencies and reduced accuracy in high-dimensional settings.

Embodiments of the present invention employ a clustering mechanism, which uses stochastic k-means clustering to divide a vector space into manageable clusters. Each cluster is defined by a centroid that represents the collective characteristics of the points within that cluster. This clustering not only simplifies the vector space but also enhances the search process by reducing the computational overhead required to search through the entire space. Clustering furthermore reduces large (Euclidean) distances within a space, as the largest distance with clustering is now between a user query (its embedding) and its closest centroid. The cluster based “pruning” of large distances eliminates a major accuracy issue found when using Euclidean distance in large high-dimensional spaces.

Following the clustering, embodiments of the present invention perform a search process that leverages the K-Nearest Neighbor (KNN) algorithm to efficiently locate and retrieve data points within these clusters. The search begins with the calculation of distances between a user's query, represented as a prompt embedding, and the centroids of these clusters. The system prioritizes clusters based on their proximity to the prompt embedding, ensuring that searches are concentrated in areas most likely to contain relevant information.

Embodiments of the present invention use Euclidean distance to measure the similarity between the prompt embedding and points within the clusters, rather than relying on the traditional cosine similarity. This approach allows for more granular and precise measurements of semantic relevance, particularly beneficial in dense vector spaces where Euclidean distance can provide more nuanced distinctions than cosine similarity.

The combination of these techniques—optimized clustering, efficient search prioritization, and the use of Euclidean distance—constitutes a significant improvement to the underlying technology of semantic search systems. Embodiments of the present invention not only enhance the performance and accuracy of searches within large language models but also address the scalability challenges posed by high-dimensional data environments.

In one embodiment, a computer-implemented method for semantic search optimization in high-dimensional vector spaces may comprise receiving a user query and generating a prompt embedding from the user query, wherein the prompt embedding comprises a numerical vector in a high-dimensional vector space. The method may further comprise calculating Euclidean distances between the prompt embedding and a plurality of cluster centers in the high-dimensional vector space, wherein each cluster center represents a cluster of data points, and identifying a jump point as the cluster center having the shortest Euclidean distance to the prompt embedding. The method may also comprise performing a sequential cluster search starting from the jump point and proceeding in ascending order of Euclidean distance from the prompt embedding, the sequential cluster search comprising, for each cluster searched, performing a K-Nearest Neighbor (KNN) search within the cluster to calculate Euclidean distances between the prompt embedding and data points within the cluster, selecting a set of top data points having the shortest Euclidean distances to the prompt embedding, and computing semantic relevance scores for the selected top data points using a relevance function based on the calculated Euclidean distances.

Other features and advantages of various aspects and embodiments of the present invention will become apparent from the following description and from the claims.

### BRIEF DESCRIPTION OF THE DRAWINGS

FIG. 1 is an illustration of a knowledge space according to one embodiment of the present invention.

FIG. 2 illustrates how a vector space has been clustered to produce a corresponding cluster space containing a plurality of clusters according to one embodiment of the present invention.

FIG. 3 is a schematic illustration of a search process performed by an embodiment of the present invention.

FIG. 4 is a flowchart illustrating a method for semantic search optimization in high-dimensional vector spaces according to one embodiment of the present invention.

FIG. 5 is a block diagram illustrating a semantic search optimization system according to one embodiment of the present invention.

### DETAILED DESCRIPTION

Semantic search across vector embeddings is a pivotal function for the effective use of large language models (LLMs), particularly when employed alongside a method known as Retrieval Augmented Generation (RAG). RAG is gaining traction among enterprises that prefer to utilize their proprietary content without the risks associated with traditional model fine-tuning. RAG enhances the utility of LLMs by inserting relevant context from a vector database-such as corporate content-directly into the prompt. This process mitigates the need for enterprises to fine-tune LLMs with their sensitive data, which could potentially expose confidential information through sophisticated prompt engineering attacks and also incurs significant costs.

The effectiveness of RAG, and by extension the LLM's response quality, hinges critically on the model's ability to integrate and utilize the provided context accurately. This capability allows enterprises to leverage the sophisticated language generation features of LLMs with content that the model has not previously encountered. Consequently, the quality of an LLM's response to a user's query predominantly depends on two factors: the inherent ability of the model to generate coherent and contextually appropriate language, and the quality of the context data fed into the model.

Embodiments of the present invention introduce an innovative approach to enhance the semantic search process by optimizing how context is selected and integrated into the LLM. By refining the search mechanism within high-dimensional vector spaces through a novel combination of clustering and Euclidean distance measurements, embodiments of the present invention may be used to significantly improve the relevance and accuracy of the context provided to the LLM. This advancement not only preserves the confidentiality and integrity of enterprise data, but also reduces the computational overhead typically associated with traditional semantic search methods.

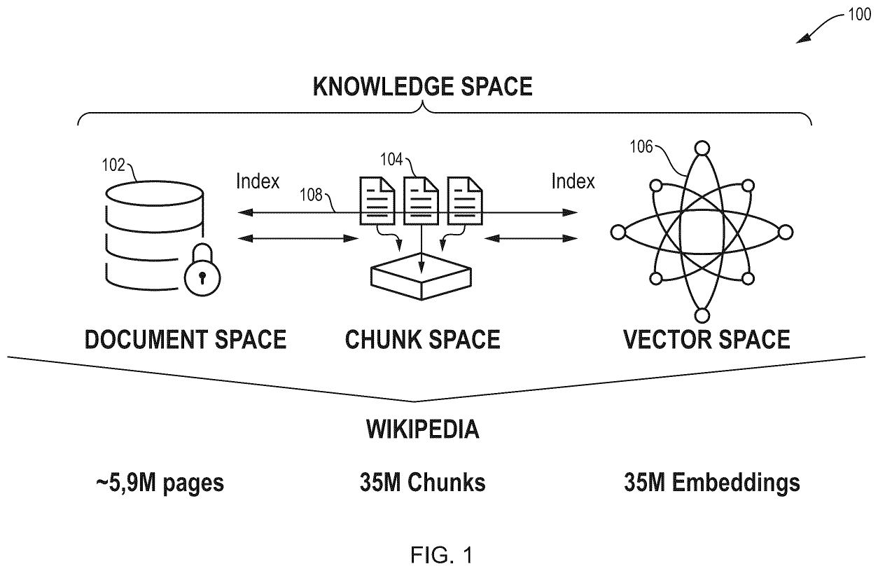

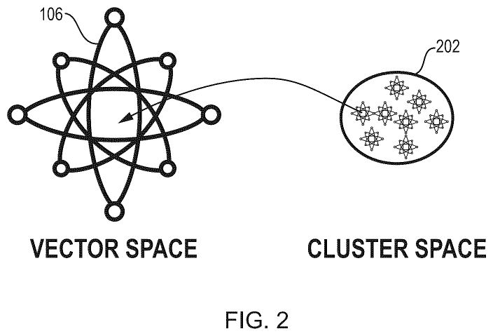

Referring to FIG. 1, an illustration of what is referred to herein as knowledge space 100 is depicted. In this example, the knowledge space 100 encompasses the entire contents of English Wikipedia, although this is merely illustrative. More broadly, the knowledge space 100 can represent the content of any digital data repository or repositories. As shown in FIG. 1, the knowledge space 100 includes several components:
Document Space 102: This space contains the original documents or other data within the knowledge space 100, such as the original content of English Wikipedia.
Chunk Space 104: Resulting from the processing (e.g., cleaning, formatting, and/or converting) of content from the document space 102, this space involves chunking the processed content into fixed-size text blocks.
Vector Space 106: In this space, the chunks from the chunk space 104 are embedded, meaning they are represented as vectors within a vector database.
Index 108: The index 108 connects the embeddings in the vector space 106, the chunks in the chunk space 104, and the original content in the document space 102. This index facilitates the retrieval and contextual alignment of data across these spaces.

An objective of some embodiments of the present invention is to efficiently and accurately identify all relevant points, or chunks, within one or multiple knowledge spaces (such as the knowledge space 100 shown in FIG. 1) that are pertinent to a user's query. These relevant chunks, identified within a specified distance threshold, may then be fetched and incorporated into the user's query as contextual data using the Retrieval Augmented Generation (RAG) method. The quality and effectiveness of the search results may be influenced by several critical factors:
The Embedder Used: The choice of embedder impacts the quality of the vector embeddings. Different embedders may encode varying levels of semantic richness and contextual nuances into the vector representations of the text chunks.
The Dimensionality of the Embeddings: The number of dimensions in the embeddings affects their ability to capture and differentiate complex semantic details. Higher dimensionality can offer more detailed semantic representation, thus potentially improving the search accuracy but may also increase computational demands.
Speed and Quality of Vector Search: This factor is crucial for maintaining an efficient user experience and operational effectiveness. The search process must be fast enough to operate within acceptable response times (ideally within no more than 300-400 milliseconds) while still being thorough enough to traverse the high-dimensional vector space efficiently.
Determination of Semantic Relevance: The core of the search process involves determining the semantic relevance of each chunk relative to the user's query. This involves calculating distances in the vector space and comparing these distances against a predefined threshold to decide which chunks are sufficiently relevant to be included as context.
Determination of LLM Response's Context Adherence: After the relevant chunks are integrated into the user's query, the large language model generates a response. The quality of this response is partly determined by how well the model adheres to the provided context, maintaining coherence and relevance to the initial query. In particular, the LLM response's context adherence is closely tied to the semantic relevance calculation method used in the retrieval process. This method may use a relevance function based on Euclidean distance, which may incorporate the Alpha (α), Beta (β), Mu (μ) and Sigma (σ) parameters described in more detail below. The system 100 evaluates the context adherence of the LLM's response by comparing the semantic relevance of the response to the provided context chunks. This comparison may utilize the same Euclidean distance-based relevance function described below, thereby allowing for a consistent and precise measurement of how well the LLM has incorporated and adhered to the given context in its generated response.
Determination of LLM Response's Chunk Adherence: This factor assesses how closely the language model's response aligns with the specific chunks that were identified as relevant. Effective chunk adherence indicates that the model not only utilizes the general context but also specifically leverages the information contained within the most relevant chunks.

Together, these factors influence the speed with which the system retrieves data and the relevance and accuracy of the retrieved data in relation to the user's query.

In the context of semantic search within large vector spaces, the speed of retrieving relevant points or chunks is paramount to ensuring a seamless user experience. A realistic target for such retrieval operations is approximately 300-400 milliseconds. Exceeding this duration can lead to noticeable delays for the end-user, adversely affecting the overall user experience by making the system appear slow and less responsive.

The ability to meet this stringent time requirement depends on two factors:
Effective Subdivision of the Vector Space: This involves organizing the vector space 106 to identify the most promising areas for search, which may be thought of as “the best places to look.” Effective subdivision is valuable because it allows the search algorithm to focus on specific segments of the vector space 106 where relevant results are most likely to be found, thereby optimizing the search process.
Examination Capacity within Time t: This refers to the number of points that can be realistically examined within the designated time frame, t. The capacity to examine a sufficient number of points within this time is valuable for ensuring that the search is both comprehensive and timely.

For instance, certain embodiments of the present invention have demonstrated the ability to process approximately 100,000 points in 0.3 seconds. To put this into perspective, 100,000 points roughly equate to the content of 16,700 pages, on the basis of 6 points (embeddings) representing one page (one point/embedding=512 characters) This performance level is achieved through the implementation of two techniques:
Optimized Stochastic Clustering: This technique addresses factor (a) by organizing the vector space 106 into clusters through stochastic methods. These clusters represent meaningful subdivisions of the vector space 106, making it easier and faster to locate relevant points during a search.
K-Nearest Neighbor (KNN) Search: To tackle factor (b), embodiments of the present invention may employ a KNN search strategy. This method efficiently identifies the nearest points (or chunks/embeddings) relative to a given query within the predefined clusters (sub-spaces), ensuring that the search is both rapid and accurate.

Further details on how these strategies may be implemented are described below.

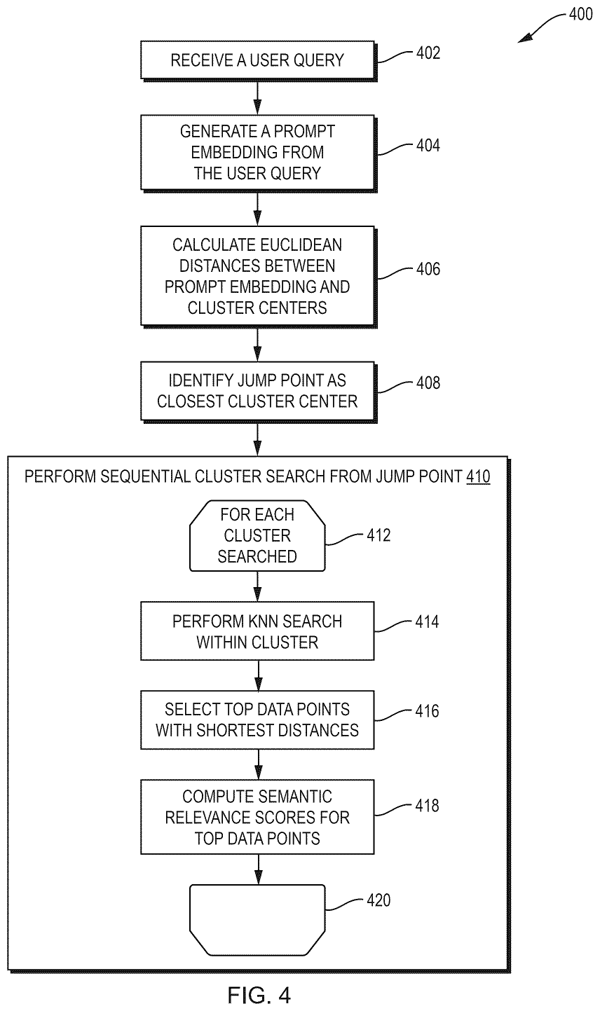

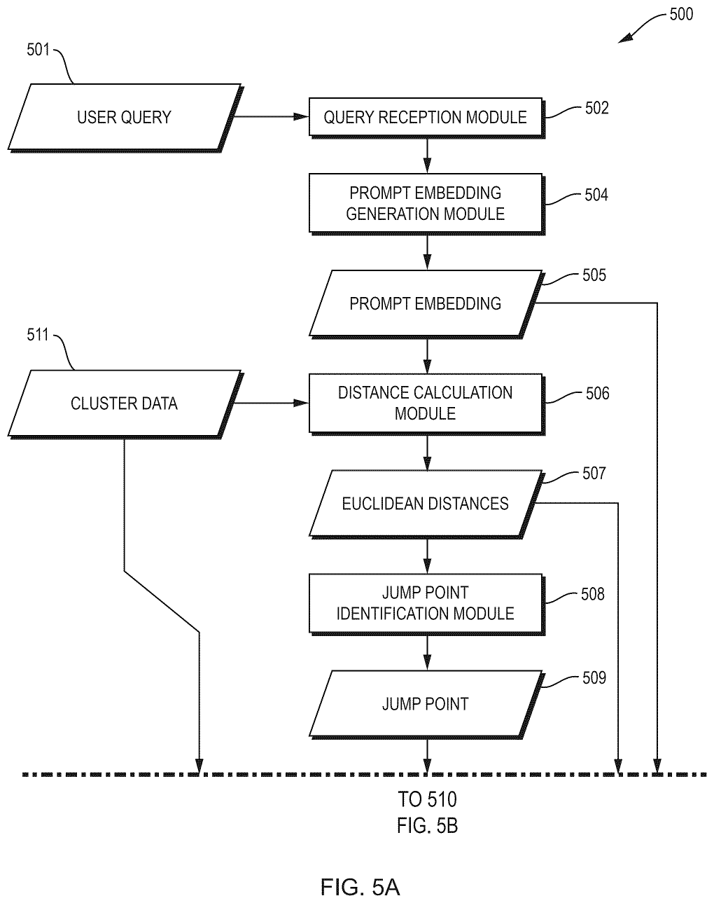

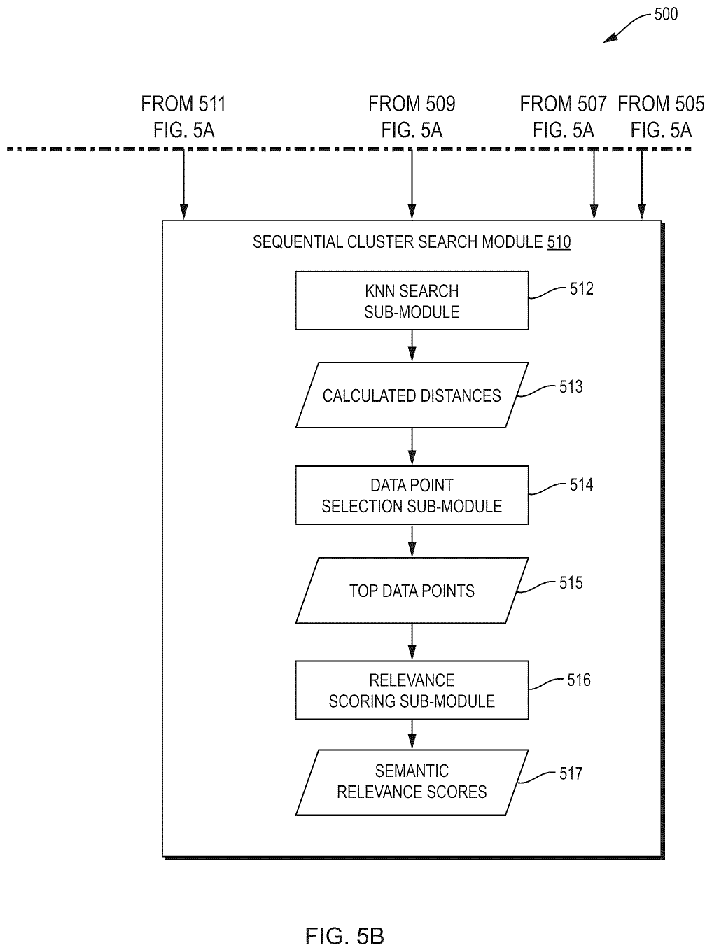

Referring to FIG. 4, a flowchart of a method 400 for semantic search optimization in high-dimensional vector spaces is shown according to one embodiment of the present invention. Referring to FIG. 5, a dataflow diagram of a system 500 for semantic search optimization in high-dimensional vector spaces is shown according to one embodiment of the present invention. The system 500 of FIG. 5 may perform the method 400 of FIG. 4.

Referring to FIG. 4, the method 400 receives a user query 501 from a user (FIG. 4, step 402). In some embodiments, step 402 may be performed by the query reception module 502 of the semantic search optimization system 500, as shown in FIG. 5. The user query 501 may comprise any textual input provided by a user seeking information from the knowledge space 100. For example, the user query 501 may include natural language questions, keyword searches, phrase-based queries, and/or structured search requests that express the user's information needs.

The user (not shown in FIG. 5) may take any of a variety of forms, including a human, a computing device, software, and/or any combination thereof. In some cases, the user may comprise an individual person interacting with the semantic search optimization system 500 through various input mechanisms. The user may also include automated systems, applications, or services that generate queries programmatically as part of larger computational workflows. Various embodiments may support multiple user types simultaneously, enabling the system 500 to serve diverse query sources and use cases.

In the case of a human user, the query reception module 502 may receive the user query 501 from the user via any kind of user interface. For example, the user interface may include web-based interfaces accessible through standard browsers, mobile applications with touch-based input capabilities, voice-activated interfaces that convert speech to text, and/or desktop applications with graphical user interfaces (GUIs). The query reception module 502 may support command-line interfaces for technical users, conversational interfaces integrated into messaging platforms, and/or specialized graphical user interfaces designed for specific domain applications. In various embodiments, the user interface may incorporate accessibility features such as screen reader compatibility, keyboard navigation support, and/or alternative input methods to accommodate users with different abilities. The graphical user interfaces may include customizable dashboards, interactive visualization components, and/or context-sensitive help systems that guide users through the query formulation process.

In the case of a computing device user, the query reception module 502 may receive the user query 501 via a network interface component over a network or local interface. The network interface component may support various communication protocols including HTTP, HTTPS, WebSocket, TCP/IP, and/or custom protocols designed for specific applications. In some cases, the network may comprise local area networks, wide area networks, the internet, private networks, and/or hybrid network configurations. The query reception module 502 may implement authentication mechanisms, encryption protocols, load balancing capabilities, and/or rate limiting features to ensure secure and efficient communication with computing device users. The local interface may include direct connections such as USB, serial interfaces, Bluetooth, and/or other proximity-based communication methods.

In the case of a software user, the query reception module 502 may receive the user query 501 via a software interface, such as an API. The API may comprise RESTful web services, GraphQL endpoints, SOAP interfaces, and/or custom protocol implementations that enable programmatic access to the semantic search optimization system 500. In various embodiments, the software interface may support different data formats including JSON, XML, Protocol Buffers, and/or binary formats depending on the requirements of the calling software. The query reception module 502 may implement API versioning, request validation, response formatting, and/or error handling mechanisms to ensure reliable software-to-software communication. The software interface may also include software development kits, client libraries, and/or integration frameworks that simplify the process of connecting external applications to the system 500.

The user query 501 received at step 402 may take various forms depending on the application context and user interface implementation. In some cases, the user query 501 may comprise short queries containing fewer than 10 words, medium-length queries containing 10 to 50 words, and/or extended queries containing more than 50 words. The query reception module 502 may be configured to accept user queries 501 in any of a variety of formats, including plain text strings, formatted text with markup elements, voice-to-text converted queries, and/or queries translated from other languages. The query reception module 502 may implement various preprocessing operations on the received user query 501, such as text normalization, character encoding standardization, whitespace trimming, and/or basic syntax validation to ensure the query is suitable for subsequent processing steps.

The query reception module 502 may perform initial query analysis during step 402 to extract metadata and/or contextual information that may enhance the search process. For example, the query reception module 502 may identify the language of the user query 501, detect named entities within the query text, classify the query type based on linguistic patterns, and/or extract temporal references that may influence search scope. In various embodiments, step 402 may include logging the received user query 501 for analytics purposes, applying content filtering to ensure appropriate query content, implementing rate limiting to prevent system abuse, and/or performing user authentication to verify query permissions. The query reception module 502 may store the processed user query 501 in a temporary buffer or queue structure, enabling efficient handoff to the prompt embedding generation module 504 for the subsequent step 404 of the method 400.

Referring to FIG. 4, the method 400 generates a prompt embedding 505 from the user query, wherein the prompt embedding 505 comprises a numerical vector in a high-dimensional vector space (FIG. 4, step 404). In some embodiments, step 404 may be performed by the prompt embedding generation module 504 of the semantic search optimization system 500.

The prompt embedding generation module 504 may receive the user query 501 from the query reception module 502 and transform the textual content into a mathematical representation suitable for computational analysis within the vector space 106. In some cases, because the query reception module 502 may perform various processing operations on the user query 501, the user query that is received by the prompt embedding generation module 504 may be a processed form of the user query 501 that was initially input by the user.

The prompt embedding generation module 504 may utilize various techniques to convert the user query 501 into the prompt embedding 505. For example, the prompt embedding generation module 504 may employ a transformer-based model, such as BERT, RoBERTa, GPT variants, T5, and/or specialized embedding models like Sentence-BERT to generate dense vector representations. In some cases, the prompt embedding generation module 504 may utilize a pre-trained embedding model that has been trained on large corpora of text data, fine-tuned embedding models customized for specific domains or applications, and/or multilingual embedding models that support cross-language semantic search capabilities. The prompt embedding generation module 504 may implement contextual embedding techniques that capture the meaning of words based on their surrounding context, static embedding approaches that provide fixed representations, and/or hybrid embedding methods that combine multiple representation strategies.

The prompt embedding generation module 504 may, for example, utilize word2vec variants including Continuous Bag of Words (CBOW) and Skip-gram architectures, GloVe embeddings that leverage global word co-occurrence statistics, FastText implementations that incorporate subword information for improved handling of out-of-vocabulary terms, domain-specific embedding models trained on specialized corpora such as medical literature or legal documents, and/or custom embedding approaches optimized for particular applications with specific vocabulary requirements or semantic nuances. In various embodiments, the prompt embedding generation module 504 may implement ensemble techniques that combine multiple embedding models, transfer learning approaches that adapt pre-trained embeddings to new domains, and/or incremental learning methods that continuously refine embedding representations based on new data.

The prompt embedding 505 generated by the prompt embedding generation module 504 may comprise a numerical vector in a high-dimensional vector space that preserves the semantic meaning and contextual relationships present in the original user query 501. The high-dimensional vector space may include vectors with at least 128 dimensions, at least 256 dimensions, at least 512 dimensions, at least 768 dimensions, at least 1024 dimensions, at least 1536 dimensions, and/or at least 2048 dimensions, depending on the specific embedding model employed. In various embodiments, the prompt embedding 505 may utilize variable-dimension embeddings that adapt size based on content complexity, fixed-dimension embeddings that maintain consistent vector lengths, compressed embeddings that reduce storage requirements through dimensionality reduction techniques, and/or expanded embeddings that increase dimensionality for enhanced semantic granularity.

The prompt embedding generation module 504 may implement various preprocessing and optimization techniques during step 404 to enhance the quality and effectiveness of the generated prompt embedding 505. The prompt embedding generation module 504 may perform text preprocessing operations including tokenization, normalization of character encodings, removal of formatting artifacts, standardization of whitespace and punctuation, and/or extraction of meaningful content from markup languages. In some cases, the prompt embedding generation module 504 may apply natural language processing techniques such as stemming, lemmatization, named entity recognition, part-of-speech tagging, and/or syntactic parsing to enhance the semantic representation of the user query 501. The prompt embedding generation module 504 may also implement query expansion techniques that augment the original query with related terms, synonym replacement methods that normalize vocabulary variations, and/or context enrichment approaches that incorporate additional semantic information.

The prompt embedding generation module 504 may support various numerical precision formats and optimization strategies to balance accuracy with computational efficiency. The prompt embedding 505 may utilize 32-bit floating point representations for high precision applications, 16-bit floating point formats for memory-constrained environments, 8-bit quantized representations for edge computing deployments, and/or mixed-precision formats that optimize different vector components based on their semantic importance. The prompt embedding generation module 504 may implement caching mechanisms that store frequently used embeddings, batch processing capabilities that generate multiple embeddings simultaneously, and/or streaming processing approaches that handle real-time embedding generation for continuous query streams.

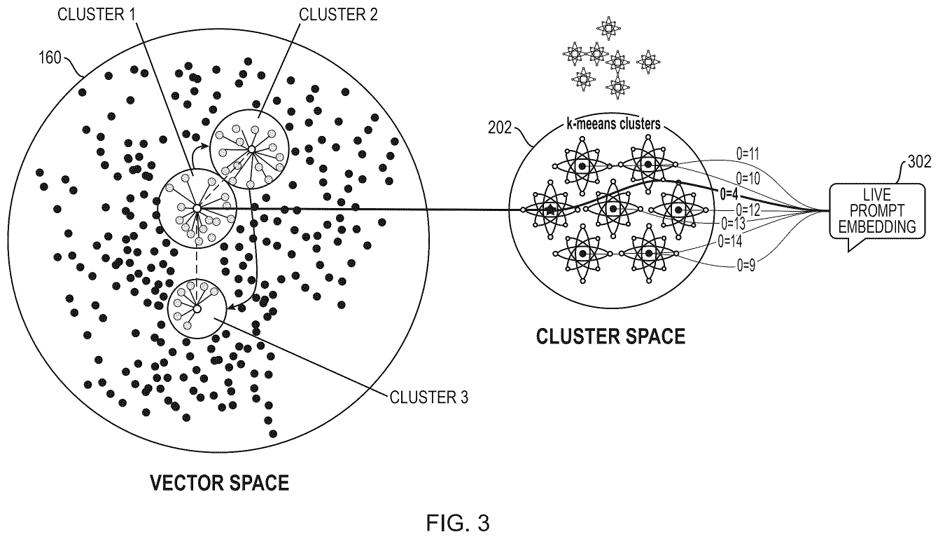

Referring to FIG. 3, the vector space 106 may be organized into what is referred to herein as a cluster space 202. The transformation from the vector space 106 to the cluster space 202 may be illustrated through the systematic organization of distributed data points into distinct clusters. The vector space 106 shown on the left side of FIG. 3 contains numerous data points distributed across the high-dimensional space, while the cluster space 202 on the right side demonstrates how these same data points may be reorganized into manageable clusters represented by atomic-like structures. For example, FIG. 2 shows an example in which the vector space 106 has been clustered to produce a corresponding cluster space 202, which includes a plurality of clusters. The particular number of clusters shown in FIG. 2 is merely an example.

The primary purpose of clustering in the context of semantic search optimization is to create a structured framework within the vector space 106 by forming clusters, each of which has a center point (centroid). Each cluster's centroid may be representative of the characteristics and features of the points (or chunks) within that cluster. By defining these centroids, the vector space 106 may be more efficiently navigated during search operations, as each centroid may act as a reference point that summarizes the properties of its cluster.

In particular, during an onboarding phase, any of a variety of clustering methods, such as stochastic k-means clustering, may be applied to the vector space 106 to produce the cluster space 202. Embodiments of the present invention may implement various clustering approaches including hierarchical clustering methods that organize data in tree-like structures, density-based clustering algorithms such as DBSCAN that identify clusters based on point density, spectral clustering techniques that utilize eigenvalue decomposition for cluster identification, Gaussian mixture models that assume probabilistic distributions, and/or adaptive clustering approaches that adjust parameters based on data characteristics.

The number of clusters may, for example, be determined based on the size of the vector space 106. One way of doing this is to calculate the number of clusters as the square root of the total number of points or chunks. In some cases, this calculation may involve computing an approximated square root of the total number of data points for computational efficiency. The approximated square root calculation may be subject to predefined performance boundaries that account for available memory, processing time constraints, and accuracy requirements. The number of clusters may be adjusted from the initial square root-based calculation to reduce computational overhead during clustering while maintaining search accuracy within specified tolerance ranges.

In various embodiments, determining the number of clusters may involve analyzing vector space density characteristics to identify regions of high and low data point concentration, evaluating embedding distribution patterns through statistical analysis of vector distributions, and dynamically adjusting the number of clusters based on real-time performance metrics such as search response times, accuracy measurements, and computational resource utilization. For instance, in an implementation using a Wiki knowledge space, approximately 6,000 clusters may be formed using the square root approach. In some cases, the clustering may be performed outside of the method 400 and system 500, and the method 400 and system 500 may operate on pre-generated clusters.

As will be described in more detail below, by organizing the vector space 106 into clusters in the cluster space 202, the search algorithm may more quickly locate the cluster most likely to contain relevant points, significantly reducing the number of comparisons and computations needed.

Referring to FIG. 4, the method 400 calculates Euclidean distances between the prompt embedding 505 and a plurality of cluster centers in the high-dimensional vector space, wherein each cluster center represents a cluster of data points (FIG. 4, step 406). In some embodiments, step 406 may be performed by the distance calculation module 506 of the semantic search optimization system 500, as shown in FIG. 5. The distance calculation module 506 may receive the prompt embedding 505 from the prompt embedding generation module 504 and cluster data 511 that may include various information about clusters within the cluster space 202. For example, the cluster data 511 may include cluster center coordinates, cluster boundaries, cluster membership information, cluster statistical properties, cluster metadata, cluster quality metrics, cluster relationship mappings, and/or any other data characterizing the clusters and their organization within the high-dimensional vector space.

The distance calculation module 506 may implement various computational approaches to calculate the Euclidean distances 507 between the prompt embedding 505 and each cluster center in the high-dimensional vector space. For example, the distance calculation module 506 may utilize K-Nearest Neighbor (KNN) search to compute these distances efficiently. The KNN search may identify the closest cluster centers to the prompt embedding 505 based on Euclidean distance measurements. The result of these computations may be a set of distances that are sorted in ascending order, with the closest cluster centers appearing first in the sorted list. This sorted arrangement facilitates the subsequent search process by enabling a sequential examination of clusters based on their proximity to the prompt embedding 505.

In some cases, the distance calculation module 506 may implement weighted Euclidean distance calculations that determine importance weights based on semantic significance, domain-specific requirements, and/or learned feature importance from training data. The distance calculation module 506 may apply these importance weights to different embedding dimensions and compute weighted Euclidean distances accordingly. The distance calculation module 506 may dynamically adjust the importance weights based on feedback from search performance metrics, user interactions, accuracy measurements, and/or system optimization algorithms to improve the effectiveness of distance calculations over time.

Referring to FIG. 4, the method 400 identifies a jump point 509 as the cluster center having the shortest Euclidean distance to the prompt embedding (FIG. 4, step 408). In some embodiments, step 408 may be performed by the jump point identification module 508 of the semantic search optimization system 500, as shown in FIG. 5. As further shown in FIG. 3, the live prompt embedding 302 may serve as the reference point for determining cluster proximity, with the system 500 calculating distances between the live prompt embedding 302 and each cluster center within the cluster space 202 to identify the optimal starting location for the sequential search process. The jump point identification module 508 may receive the Euclidean distances 507 from the distance calculation module 506 and analyze these distances to determine which cluster center exhibits the minimum distance value relative to the prompt embedding 505. The jump point 509 may act as the entry point into the larger vector space 106, guiding the subsequent search process through the most promising regions of the high-dimensional space.

The jump point identification module 508 may implement any of a variety of techniques to efficiently identify the cluster center with the shortest Euclidean distance to the prompt embedding 505. For example, the jump point identification module 508 may utilize minimum-finding algorithms that scan through the calculated Euclidean distances 507 to locate the smallest distance value, sorting algorithms that arrange distances in ascending order to identify the first element, and/or comparison-based selection methods that iteratively evaluate distance values to determine the optimal cluster center. By starting the search at the jump point 509, embodiments of the present invention may efficiently narrow down the search area to the most relevant region of the vector space 106.

The jump point 509 identified by the jump point identification module 508 may serve as the starting location for subsequent search operations within the cluster space 202. The jump point 509 may represent the cluster center that exhibits the highest probability of containing data points semantically relevant to the user query 501, based on the proximity of the cluster center to the prompt embedding 505 in the high-dimensional vector space.

In various embodiments, the jump point identification module 508 may store additional metadata associated with the jump point 509, including the specific distance value between the jump point 509 and the prompt embedding 505, the cluster identifier corresponding to the jump point 509, cluster population statistics, and/or cluster quality metrics that may influence subsequent search operations. This strategic selection of a starting point may optimize the search process and improve response times by focusing computational resources on the most promising areas of the vector space 106.

The jump point identification module 508 may support various optimization strategies and performance enhancements that improve the efficiency of the jump point 509 identification process. The jump point identification module 508 may utilize caching mechanisms that store previously identified jump points 509 for similar prompt embeddings 505, approximation algorithms that provide near-optimal jump point 509 selection with reduced computational overhead, and/or adaptive selection criteria that adjust jump point 509 identification based on historical search performance metrics.

The jump point identification module 508 may implement distributed processing capabilities that enable jump point 509 identification across multiple computational nodes, real-time processing features that support continuous jump point 509 updates as new cluster data 511 becomes available, and/or batch processing modes that efficiently handle multiple jump point 509 identification requests simultaneously. As further shown in FIG. 5, the jump point 509 serves as a critical input to the sequential cluster search module 510, thereby establishing the foundation for an efficient traversal of the vector space 106 during the semantic search process.

Referring to FIG. 4, the method 400 performs a sequential cluster search starting from the jump point and proceeding in ascending order of Euclidean distance from the prompt embedding (FIG. 4, step 410). In some embodiments, step 410 may be performed by the sequential cluster search module 510 of the semantic search optimization system 500, as shown in FIG. 5.

With continued reference to FIG. 3, the sequential cluster search may proceed through the organized cluster space 202, where each atomic-like cluster structure represents a collection of semantically related data points. The connecting lines between clusters in FIG. 3 may illustrate the systematic traversal path that the sequential cluster search module 510 follows when proceeding in ascending order of Euclidean distance from the live prompt embedding 302.

The sequential cluster search module 510 may receive multiple inputs including the jump point 509 from the jump point identification module 508, the Euclidean distances 507 from the distance calculation module 506, the prompt embedding 505 from the prompt embedding generation module 504, and cluster data 511 that provides information about the organization and structure of clusters within the cluster space 202.

The search process may begin with the cluster that is closest to the prompt embedding 505 (the jump point 509) and proceed in ascending order of distance, as indicated by the previously-computed Euclidean distances 507. This approach ensures that clusters most likely to contain relevant information are examined first, thereby increasing the efficiency of the search and optimizing the retrieval of semantically similar data points. The sequential cluster search module 510 may implement a systematic traversal strategy that begins at the jump point 509 and progresses through clusters in a predetermined order based on their proximity to the prompt embedding 505. This sequential approach may ensure that clusters most likely to contain semantically relevant data points are examined first, thereby optimizing the efficiency of the search process.

The sequential cluster search module 510 may utilize the sorted Euclidean distances 507 to determine the order in which clusters are processed, with clusters having shorter distances to the prompt embedding 505 receiving higher priority in the search sequence. In various embodiments, the sequential cluster search module 510 may implement queue-based processing mechanisms that maintain the ordered sequence of clusters, priority scheduling algorithms that manage cluster processing based on distance rankings, and/or adaptive sequencing strategies that adjust the search order based on real-time performance metrics and search results.

Embodiments of the present invention may implement alternative search sequencing strategies that accomplish the fundamental purpose of systematically examining clusters. For example, the sequential cluster search module 510 may employ priority-based sequencing that incorporates additional relevance factors beyond Euclidean distance, such as cluster density, historical query patterns, and/or semantic domain characteristics.

The sequential cluster search module 510 may implement adaptive ordering based on cluster characteristics including size variations, internal distance distributions, content diversity metrics, and/or quality indicators derived from previous search operations. In some cases, the sequential cluster search module 510 may utilize parallel cluster processing that examines multiple clusters simultaneously while maintaining logical ordering principles, enabling improved throughput on multi-core processors and distributed computing environments.

The sequential cluster search performed by the sequential cluster search module 510 may incorporate various optimization techniques that enhance search efficiency while maintaining accuracy in identifying relevant data points. The sequential cluster search module 510 may implement early termination criteria that halt the search process when sufficient relevant results have been identified, distance threshold mechanisms that exclude clusters beyond a specified proximity range, and/or dynamic search scope adjustments that modify the number of clusters examined based on the quality of results obtained from initial clusters.

In some cases, the sequential cluster search module 510 may utilize parallel processing capabilities that enable simultaneous examination of multiple clusters while maintaining the overall sequential ordering, load balancing algorithms that distribute cluster processing across available computational resources, and/or caching mechanisms that store intermediate search results to avoid redundant computations during subsequent operations.

Referring to FIG. 4, the sequential cluster search performed at step 410 may include a loop control mechanism 518 that systematically processes each cluster in ascending order of Euclidean distance from the prompt embedding 505. The loop may be initiated at step 412, which establishes the iterative framework for examining clusters sequentially. For purposes of the subsequent discussion, the term “the current cluster” is used to refer to the cluster being searched in the current iteration of the loop defined by steps 412-420.

The loop control mechanism 518 may maintain state information about the current cluster, remaining clusters, and performance metrics that influence search continuation or termination. In some cases, the loop control mechanism 518 may implement dynamic termination conditions based on result quality, computational resource constraints, and/or user-defined parameters.

As shown in FIG. 4, the loop continues through step 420, which may serve as the iteration control point determining whether additional clusters should be processed based on criteria such as unprocessed cluster availability, achievement of sufficient search results, and/or consumption of allocated resources. Upon completion of the loop, the sequential cluster search module 510 may have processed all relevant clusters or reached a termination condition indicating sufficient search coverage has been achieved.

Referring to FIG. 4, the method 400 performs a K-Nearest Neighbor (KNN) search within the current cluster to calculate Euclidean distances between the prompt embedding and data points within the cluster (FIG. 4, step 414). In some embodiments, step 414 may be performed by the KNN search sub-module 512 of the sequential cluster search module 510 within the semantic search optimization system 500, as shown in FIG. 5. The KNN search sub-module 512 may receive the prompt embedding 505 and cluster data 511 as inputs, enabling the sub-module to focus the search operations on the specific cluster currently being processed within the sequential cluster search. This targeted approach allows the KNN search sub-module 512 to efficiently examine only the data points contained within the current cluster, rather than searching across the entire vector space 106. By calculating the Euclidean distance from each point within the cluster to the prompt embedding 505, the KNN search sub-module 512 identifies the specific points within each cluster that are closest to the user query 501, and therefore most likely to be semantically relevant.

The KNN search sub-module 512 may implement various algorithmic approaches to perform the KNN search within each cluster during step 414. For example, the KNN search sub-module 512 may utilize brute-force distance calculations that compute Euclidean distances between the prompt embedding 505 and every data point within the current cluster. The sub-module may employ tree-based search algorithms such as k-d trees or ball trees that partition the cluster space for efficient nearest neighbor identification, and/or hash-based approaches such as locality-sensitive hashing that approximate nearest neighbors with reduced computational overhead.

The KNN search sub-module 512 may employ specialized libraries such as FAISS (Facebook AI Similarity Search), Annoy (Approximate Nearest Neighbors Oh Yeah), or scikit-learn's NearestNeighbors implementation to optimize search performance within individual clusters. In various embodiments, the KNN search sub-module 512 may implement parallel processing techniques that distribute distance calculations across multiple computational threads, vectorized operations that leverage SIMD capabilities for simultaneous distance computations, and/or GPU acceleration that utilizes graphics processing units for high-throughput distance calculations.

As further shown in FIG. 5, the KNN search sub-module 512 generates calculated distances 513 as output, which represent the Euclidean distances between the prompt embedding 505 and the data points within the cluster being searched. The calculated distances 513 may be organized in various formats to facilitate subsequent processing operations, including sorted arrays that arrange distances in ascending order, priority queues that maintain the k-nearest neighbors during search operations, and/or associative data structures that link distance values to their corresponding data point identifiers.

The KNN search sub-module 512 may implement distance caching mechanisms that store previously computed distances for reuse across multiple search iterations, approximate distance calculations that provide sufficient accuracy with reduced computational cost, and/or early termination strategies that halt distance calculations when sufficient nearest neighbors have been identified.

Referring to FIG. 4, the method 400 selects a set of top data points having the shortest Euclidean distances to the prompt embedding (FIG. 4, step 416). In some embodiments, step 416 may be performed by the data point selection sub-module 514 of the sequential cluster search module 510 within the semantic search optimization system 500, as shown in FIG. 5. The data point selection sub-module 514 may receive the calculated distances 513 from the KNN search sub-module 512 as input, enabling the sub-module to identify and select the most relevant data points within the current cluster based on their proximity to the prompt embedding 505. This selection process may focus on data points that exhibit the smallest Euclidean distances to the prompt embedding 505, thereby ensuring that the most semantically similar content is prioritized for subsequent relevance scoring operations.

The data point selection sub-module 514 may implement various selection strategies and ranking mechanisms to identify the top data points during step 416. For example, the data point selection sub-module 514 may utilize threshold-based selection that identifies all data points within a specified distance range, fixed-count selection that retrieves a predetermined number of closest data points, and/or percentile-based selection that selects the top percentage of data points based on distance rankings.

The data point selection sub-module 514 may employ adaptive selection criteria that adjust the number of selected data points based on cluster characteristics, distance distribution patterns within the cluster, and/or quality metrics derived from the calculated distances 513. In various embodiments, the data point selection sub-module 514 may implement multi-tier selection processes that apply different selection criteria at various stages, weighted selection algorithms that consider additional factors beyond distance measurements, and/or dynamic selection thresholds that adapt based on the overall search context and performance requirements.

In some cases, the data point selection sub-module 514 may utilize statistical analysis methods that examine the distribution of calculated distances 513 to identify natural breakpoints for selection thresholds, outlier detection mechanisms that exclude data points with anomalous distance characteristics, and/or clustering validation approaches that verify the appropriateness of selected data points within the current cluster context. The data point selection sub-module 514 may implement performance optimization features such as parallel selection processing that handles multiple data point evaluations simultaneously, memory-efficient selection algorithms that minimize resource consumption during large-scale operations, and/or incremental selection updates that efficiently incorporate new data points as they become available.

As further shown in FIG. 5, the data point selection sub-module 514 generates top data points 515 as output, which represent the selected subset of data points that exhibit the shortest Euclidean distances to the prompt embedding 505 within the current cluster. The top data points 515 may be organized in various formats to facilitate subsequent processing operations, including ranked lists that maintain distance-based ordering, indexed collections that enable rapid access to individual data points, and/or structured datasets that include both data point content and associated metadata.

The data point selection sub-module 514 may implement result caching mechanisms that store selected top data points 515 for reuse across multiple search iterations, compression techniques that reduce storage requirements for large selection sets, and/or serialization capabilities that enable efficient transfer of selected data points to downstream processing modules. The top data points 515 produced by the data point selection sub-module 514 serve as input to the relevance scoring sub-module 516, enabling the subsequent computation of semantic relevance scores for the most promising data points identified within each cluster during the sequential cluster search process.

Referring to FIG. 4, the method 400 computes semantic relevance scores for the selected top data points using a relevance function based on the calculated Euclidean distances (FIG. 4, step 418). In some embodiments, step 418 may be performed by the relevance scoring sub-module 516 of the sequential cluster search module 510 within the semantic search optimization system 500, as shown in FIG. 5. The relevance scoring sub-module 516 may receive the top data points 515 from the data point selection sub-module 514 and the calculated distances 513 from the KNN search sub-module 512 as inputs, enabling the sub-module to quantify the semantic similarity between each selected data point and the prompt embedding 505. This scoring process may transform raw distance measurements into normalized relevance values that provide a standardized measure of semantic similarity across different clusters and search contexts.

The relevance scoring sub-module 516 may implement various distance metrics for computing semantic relevance scores, including Euclidean distance for geometric similarity measurements, cosine similarity for angular relationship analysis between embedding vectors, Jaccard similarity for measuring overlap between sets of features or dimensions in the embeddings, and/or Hamming distance for binary or discrete embedding representations. The selection of distance metric may be based on embedding characteristics such as vector density and dimensionality, application requirements including accuracy versus speed trade-offs, domain-specific considerations, and/or performance optimization criteria.

To determine the semantic relevance of a data point P (representing individual data points within clusters) relative to the prompt embedding 505 (representing the current user query being processed), the system 500 may calculate the Euclidean distance D between P and the prompt embedding 505. These Euclidean distance calculations may be performed by the KNN search sub-module 512 and are represented by the calculated distances 513 in FIG. 5. The data point selection sub-module 514 then uses these calculated distances to identify the top data points 515 with the shortest distances to the prompt embedding 505. The relevance scoring sub-module 516 may implement various relevance function methodologies to compute semantic relevance scores during step 418, including distance-based scoring functions that inversely correlate relevance with Euclidean distance measurements, normalized scoring algorithms that scale relevance values to predetermined ranges, and/or probabilistic scoring approaches that express relevance as likelihood values between 0 and 1.

In some embodiments, the system 500 may define the relevance function based on this distance D, with the following characteristics: For very small distances, the relevance may be set to a maximum relevance value (e.g., 1). For very large distances, the relevance may be set to a minimum relevance value (e.g., 0). For intermediate distances, the system 500 may determine the relevance using linear interpolation between two boundary points, B1 and B2. The following formulations represent one possible implementation among many that may be employed in various embodiments of the present invention, and should not be construed as limiting:

B1=μ1+α*σ1, where the relevance is 1 when D=B1, and

B2=μ2−β*σ2, where the relevance is 0 when D=B2.

In these expressions: μ1 and σ1 represent the mean and standard deviation of the distribution of distances between each prompt embedding and its nearest neighbor in the high-dimensional vector space; μ2 and σ2 represent the mean and standard deviation of the distribution of all pairwise distances between prompt embeddings. The system 500 may calibrate the constants α and β using a test set to ensure that unrelated prompts yield a relevance of 0, while highly relevant prompts yield a relevance of 1. This calibration process helps to optimize the system 500's ability to distinguish between relevant and irrelevant information accurately. It should be understood that embodiments of the present invention may utilize many other mathematical formulations and approaches for computing semantic relevance scores, and the specific formulation described above represents just one example implementation.

As further shown in FIG. 5, the relevance scoring sub-module 516 generates semantic relevance scores 517 as output, which represent quantified measures of semantic similarity between the selected top data points 515 and the prompt embedding 505. The semantic relevance scores 517 may be formatted in various numerical representations to facilitate subsequent processing and analysis operations, including floating-point values that provide high-precision relevance measurements, integer scores that offer simplified relevance rankings, and/or percentage-based scores that express relevance as intuitive proportional values.

In some cases, the semantic relevance scores 517 may be quantified on various scales, such as, for example, a scale from 0 to 100, a scale from 0 to 1, a scale from 1 to 10, a scale from −1 to 1, and/or any other numerical range suitable for representing semantic similarity. When using a scale from 0 to 100, higher values may indicate greater semantic similarity between the content of each data point and the user query 501. The relevance scoring sub-module 516 may implement score normalization techniques that ensure consistent relevance ranges across different clusters and search contexts, ranking algorithms that order data points based on computed relevance values, and/or aggregation methods that combine multiple relevance factors into composite scores.

These scores may provide a clear and measurable indicator of relevance, enabling precise differentiation between highly relevant, moderately relevant, and minimally relevant content. The semantic relevance scores 517 produced by the relevance scoring sub-module 516 may serve as the final output of the sequential cluster search process, providing quantified measures of semantic similarity that enable effective selection and ranking of relevant content for integration into large language model prompts and retrieval augmented generation applications.

Embodiments of the present invention may compute the semantic relevance for only the top x data points—those that are closest to the prompt embedding 505. The number x may be configurable, allowing the semantic search optimization system 500 to be tailored to specific needs or performance requirements. For example, x may be set to 10, 50, 100, 500, or any other suitable value depending on the application context and computational resources available.

The relevance scoring sub-module 516 may utilize the Euclidean distance-based relevance function described above, which incorporates the Alpha (α) and Beta (β) calibration constants, as well as the Mu (μ) and Sigma (σ) statistical measures that characterize distance distributions. Alternative relevance functions may employ different mathematical formulations, statistical measures, or computational approaches while still falling within the scope of embodiments of the present invention.

By applying a relevance function to the top x data points, the semantic search optimization system 500 may precisely quantify the semantic relevance of each data point to the prompt embedding 505, thereby enhancing the accuracy and efficiency of the retrieval process. This selective approach to relevance computation may significantly reduce computational overhead while maintaining high-quality search results, as the most promising candidates have already been identified through the KNN search process performed by the KNN search sub-module 512.

The relevance scoring sub-module 516 may implement various alternative scoring methodologies beyond the specific formulations described above. For example, the relevance scoring sub-module 516 may utilize normalized distance-based scoring approaches that transform raw Euclidean distances through min-max normalization, z-score normalization, and/or logarithmic scaling. In some cases, the relevance scoring sub-module 516 may employ inverse distance functions, exponential decay functions, and/or sigmoid functions to quantify semantic similarity between data points and query embeddings.

Referring to FIG. 5, the relevance scoring sub-module 516 may implement probabilistic relevance models that express semantic similarity as likelihood estimates. These may include Gaussian probability density functions, Bayesian inference methods, and/or mixture model approaches. The relevance scoring sub-module 516 may also utilize conditional probability calculations, maximum likelihood estimation techniques, and/or entropy-based measures to quantify relevance in the high-dimensional vector space.

The relevance scoring sub-module 516 may incorporate machine learning-based scoring algorithms that learn optimal relevance functions from training data. These approaches may include neural network models, support vector regression techniques, and/or ensemble methods. With continued reference to FIG. 5, the relevance scoring sub-module 516 may implement gradient boosting algorithms, random forest models, and/or deep learning approaches to discover complex patterns in distance-relevance relationships.

Embodiments of the present invention may encompass adaptive scoring methods that dynamically adjust relevance calculations based on query characteristics and system performance. The relevance scoring sub-module 516 may implement query-specific scoring adaptations that modify relevance functions based on query length, complexity, and/or domain specificity. These may include contextual scoring adjustments, temporal scoring modifications, and/or personalization algorithms. In various embodiments, the relevance scoring sub-module 516 may utilize reinforcement learning techniques, online learning algorithms, and/or multi-objective optimization approaches to balance relevance accuracy with computational efficiency.

As further shown in FIG. 5, the relevance scoring sub-module 516 may implement hybrid scoring approaches that combine multiple methodologies. These hybrid methods may include weighted combinations of distance-based and probabilistic scoring functions, ensemble approaches that aggregate predictions from multiple models, and/or cascaded scoring systems. The relevance scoring sub-module 516 may utilize meta-learning algorithms that automatically select optimal scoring approaches, multi-criteria decision analysis techniques, and/or fuzzy logic systems that handle uncertainty in relevance assessments.

Embodiments of the present invention may have a variety of advantages, such as one or more of the following.

The structured search process described above, from prioritizing clusters to selectively calculating relevance scores, ensures that embodiments of the present invention not only retrieve data efficiently but also maintain high standards of accuracy and relevance in the results presented to the user. This method may significantly enhance the user experience by delivering precise and contextually appropriate information in response to queries.

A significant aspect of embodiments of the present invention may include using Euclidean distance, rather than cosine similarity, to compute any of the distances disclosed herein. Both Euclidean distance and cosine similarity are metrics used to gauge the similarity or difference between two vectors, but these metrics operate on different principles.

Cosine similarity calculates the cosine of the angle between two vectors, focusing primarily on the orientation of the vectors rather than their magnitude. This metric may be particularly favored in current Retrieval Augmented Generation (RAG) applications because cosine similarity may be efficiently computed using GPUs for matrix calculations and may be generally less computationally demanding than Euclidean distance, especially in high-dimensional vector spaces. Cosine similarity may be often employed alongside keyword matching, which may be regarded as one of the most precise methods for semantic vector search in non-graph-based systems.

The preference for cosine similarity over Euclidean distance in traditional systems may be driven by several factors:
1. Computational Efficiency—cosine similarity may require less computational power, making cosine similarity more suitable for quick processing in large-scale applications;
2. Handling of Sparse Data—in high-dimensional spaces, data points often become sparse, leading to significant distances between the data points, and this sparsity may render Euclidean distance less effective because the metric emphasizes the absolute differences in distance, which may be exaggerated in such environments; and
3. Distance Concentration—as the dimensionality increases, the relative distances between points tend to converge, diminishing the variance between the closest and farthest points, and this phenomenon may reduce the discriminative power of Euclidean distance in high-dimensional spaces.

In the context of vector embeddings, a critical distinction exists between sparse and dense vector embeddings. Sparse vectors may be characterized by a high dimensionality with most values being zero, making sparse vectors relatively easier to interpret and efficient for storing large volumes of high-dimensional data. In contrast, dense vectors typically feature a lower number of dimensions, but with most or all values being non-zero, making dense vectors more computationally efficient but harder to interpret. These vectors may be often derived from deep learning models.

The terms “low dimensionality” and “high dimensionality” may be misleading when discussing sparse and dense vectors. Sparse vectors typically exhibit higher dimensionality because each unique word or feature may correspond to a separate dimension. For example, 10,000 unique words would equate to 10,000 dimensions. Conversely, dense vectors, while capturing semantics in a different manner, still maintain high dimensionality, often ranging from 768 to 1024 dimensions or more. Therefore, both sparse vectors and dense vectors may be of high dimensionality.

While cosine similarity may be generally more effective with sparse embeddings due to cosine similarity's focus on the orientation of vectors rather than their magnitude, Euclidean distance excels in providing a more granular measurement of similarity in dense embeddings. This granularity may be extremely valuable for use in connection with the precise embedding content used in large language models (LLMs) today. By employing Euclidean distance in connection with dense embeddings, embodiments of the present invention effectively address many of the limitations associated with sparse embeddings, with computational time being the primary challenge that remains. This approach may ensure a more accurate and contextually relevant retrieval of information, leveraging the dense nature of modern embeddings to enhance the performance of semantic searches.

Embodiments of the present invention address the performance limitations commonly associated with Euclidean distance calculations in dense vector spaces using clustering-based optimization techniques that improve on the current state of the art. The strategic use of clustering may serve a dual purpose: narrowing the scope of the search to the most promising areas of the vector space and enhancing the precision of the search results by maintaining distance measurements within a relatively narrow range.

By organizing the vector space into clusters, embodiments of the present invention effectively minimize the need to calculate distances between points that are far apart, which may often result in less pronounced measures of similarity due to the high-dimensional nature of the space. In practice, embodiments of the present invention may operate by measuring distances between a prompt embedding and points that are relatively close to a designated cluster center. This cluster center may be selected based on the cluster center's proximity to the prompt embedding, ensuring that the distances being measured are between points that are inherently more similar or relevant to the query.

By concentrating on points near the cluster center, which itself may be close to the prompt embedding, embodiments of the present invention may leverage the granular and precise capabilities of Euclidean distance to measure semantic similarity effectively. This focused approach may not only enhance the accuracy of the similarity measurements but also significantly reduce the computational load. Referring to FIG. 3, the relationship between the vector space 106 and cluster space 202 may demonstrate how embodiments of the present invention reduce computational complexity by focusing distance calculations within localized cluster regions rather than across the entire distributed vector space 106.

These improvements may ensure that the system not only maintains high accuracy in semantic relevance determination but also operates within the necessary time constraints for practical application. These improvements may include any one or more of the following:
Effective and Efficient Clustering: Embodiments of the present invention may optimize the organization of the dense vector space by clustering the dense vector space at an ideal ratio between the number of embeddings and the number of clusters. This strategic clustering may reduce the complexity of the search space, allowing for quicker access to relevant data points. By creating distinct clusters that each represent a subset of the vector space, the system may focus search efforts more efficiently, reducing the overall computational load required for distance calculations.
Search Sequence Based on Cluster Proximity: Upon receiving a user's query, the system may embed the prompt and calculate the prompt's Euclidean distance to the centers of all clusters. The search within the vector space may then be conducted in ascending order of these distances. This approach may ensure that the clusters closest to the prompt embedding—those most likely to contain relevant information—are examined first, thereby speeding up the search process and improving the efficiency of finding pertinent results.
Efficient Usage of KNN: Within each cluster, embodiments of the present invention may utilize a K-Nearest Neighbor (KNN) search algorithm, such as by employing the FAISS library for enhanced performance. This method may efficiently identify and calculate the distances between the prompt embedding and the points within the cluster. By focusing on smaller, more manageable subsets of the vector space (clusters), the KNN search may operate more quickly and with greater accuracy.
Combination of Distance Distributions: Embodiments of the present invention may combine two distance distributions for each vector space—those between the prompt embedding and the cluster centers, and those within the clusters themselves. This dual-distribution approach may allow the system to dynamically assess and determine the semantic relevance of a large number of points in real-time. By leveraging these combined metrics, the system may more accurately identify the most relevant points, enhancing the quality of the search results while maintaining efficient processing speeds.

In particular, embodiments of the present invention may employ a novel approach to measure semantic relevance using Euclidean distance. This approach may allow for more precise and nuanced measurements of similarity between data points in high-dimensional vector spaces, particularly when compared to traditional cosine similarity methods.

This methodological innovation may allow embodiments of the present invention to capitalize on the strengths of Euclidean distance in dense vector spaces—providing detailed and nuanced similarity assessments—while mitigating the traditional drawbacks of Euclidean distance, such as the challenge of handling large distances in high-dimensional settings. Together, these strategies may enable embodiments of the present invention to effectively mitigate the inherent challenges of using Euclidean distance in dense vector spaces, particularly the high computational demands and the potential for decreased performance in high-dimensional settings. By optimizing the search process and enhancing the accuracy of relevance determination, embodiments of the present invention may provide a robust solution suitable for advanced semantic search applications using large language models.

The knowledge space 100 may take any of a variety of forms. For example, the knowledge space 100 may encompass any collection of information or data that may be organized, processed, and/or searched for semantic relevance. Embodiments of the knowledge space 100 may include digital repositories, databases, content management systems, and/or information archives that contain structured or unstructured data. The knowledge space 100 may represent any domain of knowledge, ranging from general-purpose information collections to highly specialized technical databases. In some cases, the knowledge space 100 may span multiple data sources, platforms, and/or formats, providing a unified framework for semantic search operations across diverse information landscapes.

Embodiments of the knowledge space 100 may include specific types of content repositories and data structures. For example, the knowledge space 100 may comprise encyclopedic content such as Wikipedia, academic databases containing research papers and publications, corporate knowledge bases storing internal documentation and procedures, and/or legal databases containing case law and regulatory information. The knowledge space 100 may also include multimedia repositories containing images, videos, and/or audio files with associated metadata, social media platforms with user-generated content, news archives spanning multiple years or decades, and/or e-commerce platforms with product catalogs and customer reviews. In various embodiments, the knowledge space 100 may encompass technical documentation repositories, software code repositories, patent databases, medical literature collections, financial data repositories, and/or real-time data streams such as news feeds, social media updates, sensor data, and market information.

Embodiments of the knowledge space 100 may be characterized by specific implementation details and technical configurations. For example, the knowledge space 100 may contain at least 1,000 files, at least 100,000 files, at least 1 million files, at least 100 million files, or at least 1 billion files. In some cases, individual files within the knowledge space 100 may include at least 100 characters, at least 1000 characters, at least 100,000 characters, or at least 1 million characters. The knowledge space 100 may be stored using various database technologies, including relational databases such as PostgreSQL, MySQL, and Oracle, NoSQL databases such as MongoDB, Cassandra, and DynamoDB, and/or graph databases such as Neo4j and Amazon Neptune. Embodiments of the knowledge space 100 may utilize distributed storage systems such as Hadoop Distributed File System (HDFS), Amazon S3, Google Cloud Storage, and/or Microsoft Azure Blob Storage. The knowledge space 100 may be implemented using cloud computing platforms, on-premises servers, hybrid cloud architectures, and/or edge computing infrastructures. In various embodiments, the knowledge space 100 may support multiple data formats including JSON, XML, CSV, Parquet, Avro, and/or proprietary binary formats, enabling flexible data ingestion and processing capabilities.

The document space 102 may encompass any collection of original source materials that serve as the foundation for semantic search operations. Embodiments of the document space 102 may include any form of textual, multimedia, or structured content that contains information suitable for processing and analysis. The document space 102 may represent the raw, unprocessed state of information before transformation into searchable formats, providing the source material from which embeddings and vector representations are ultimately derived.

Embodiments of the document space 102 may include various categories of content repositories and information sources. For example, the document space 102 may comprise text-based documents such as research papers, technical manuals, legal contracts, policy documents, and/or regulatory filings. The document space 102 may also include web-based content such as HTML pages, blog posts, forum discussions, wiki articles, and/or online documentation. In some cases, the document space 102 may encompass multimedia content including PDF files with embedded text, presentation slides, spreadsheets with textual data, documents containing mixed media elements, and/or structured data sources such as database records, XML files, JSON documents, CSV files, and API responses containing textual information.

The document space 102 may be characterized by specific organizational structures and content formats that facilitate subsequent processing operations. For example, the document space 102 may contain documents organized in hierarchical folder structures, tagged with metadata classifications, indexed by creation dates, and/or categorized by subject matter domains. In some cases, documents within the document space 102 may include version control information, access permissions, authorship details, revision histories, embedded formatting, hyperlinks, images, tables, and/or other structural elements that provide context for the contained information. The document space 102 may support various file formats including Microsoft Office documents, Google Workspace files, Adobe PDF files, plain text files, and/or proprietary document formats.

Referring to FIG. 1, the document space 102 may be implemented using various storage and management technologies that enable efficient access and processing of source materials. The document space 102 may utilize file systems such as NTFS, ext4, APFS, and/or distributed file systems for document storage. In some cases, the document space 102 may be implemented using content management systems such as SharePoint, Confluence, Drupal, and/or custom document management platforms. The document space 102 may include documents stored in enterprise systems such as customer relationship management platforms, enterprise resource planning systems, knowledge management databases, and/or collaborative workspaces.

The document space 102 may contain documents of varying sizes and complexity levels to accommodate different types of information sources. For example, individual documents within the document space 102 may range from short messages containing fewer than 100 characters to comprehensive reports containing more than 1 million characters. The document space 102 may encompass collections containing at least 100 documents, at least 10,000 documents, at least 1 million documents, and/or at least 100 million documents, depending on the scope and scale of the semantic search application.

The chunk space 104 may encompass any intermediate processing layer that transforms original document content into structured, manageable units suitable for vector embedding operations. Embodiments of the chunk space 104 may include any systematic organization of processed textual content that bridges the gap between raw documents and their corresponding vector representations. The chunk space 104 may represent a structured collection of text segments that have been extracted, cleaned, formatted, and/or optimized for subsequent embedding generation processes.

Embodiments of the chunk space 104 may include various approaches to content segmentation and organization. For example, the chunk space 104 may comprise fixed-size text blocks created through character-based segmentation, sentence-based divisions that preserve grammatical boundaries, paragraph-based chunks that maintain topical coherence, and/or semantic segments that group related concepts together. The chunk space 104 may include overlapping text windows that provide contextual continuity between adjacent chunks, sliding window segments with configurable overlap ratios, hierarchical chunks that nest smaller segments within larger contextual blocks, and/or adaptive segments that adjust size based on content complexity. In various embodiments, the chunk space 104 may encompass document-aware chunks that respect structural boundaries such as sections and chapters, metadata-enriched segments that include contextual information, multi-modal chunks that combine textual content with associated media references, and/or cross-referenced segments that maintain links to related content across documents.

The chunk space 104 may be characterized by specific processing methodologies and structural configurations that optimize content for embedding generation. The chunk space 104 may implement text preprocessing operations including normalization of character encodings, removal of formatting artifacts, standardization of whitespace and punctuation, and/or extraction of meaningful content from markup languages. In some cases, the chunk space 104 may apply content filtering techniques such as removal of boilerplate text, elimination of navigation elements, extraction of main content areas, and/or identification of relevant textual passages. The chunk space 104 may utilize natural language processing techniques including tokenization, stemming, lemmatization, named entity recognition, and/or part-of-speech tagging to enhance content structure and meaning preservation.

The chunk space 104 may support various chunk size configurations and optimization strategies to balance semantic coherence with computational efficiency. For example, chunks within the chunk space 104 may range from 128 to 2048 characters, 256 to 1024 characters, 512 to 768 characters, and/or 100 to 500 words, depending on the specific requirements of the embedding model and application context. In some cases, the chunk space 104 may implement dynamic sizing algorithms that adjust chunk boundaries based on content density, semantic breaks, syntactic structures, and/or topic transitions. The chunk space 104 may maintain chunk overlap ratios ranging from 10% to 50%, 15% to 30%, and/or 20% to 25% to ensure contextual continuity between adjacent segments.

The chunk space 104 may incorporate various metadata and indexing structures that facilitate efficient retrieval and correlation with source documents and generated embeddings. The chunk space 104 may store chunk identifiers, source document references, positional information within original documents, creation timestamps, processing version information, and/or quality metrics for each text segment. In some cases, the chunk space 104 may include semantic annotations, topic classifications, language detection results, readability scores, and/or content type indicators that provide additional context for downstream processing operations. The chunk space 104 may implement indexing structures such as hash tables, B-trees, inverted indexes, and/or graph-based representations that enable rapid chunk lookup and retrieval operations.

The chunk space 104 may be implemented using various storage technologies and data structures that optimize performance for large-scale text processing operations. The chunk space 104 may utilize in-memory data structures such as arrays, linked lists, hash maps, and/or tree structures for rapid access during processing workflows. In some cases, the chunk space 104 may employ persistent storage solutions including relational databases with text-optimized schemas, document-oriented databases such as MongoDB and CouchDB, key-value stores such as Redis and DynamoDB, and/or specialized text processing frameworks such as Apache Lucene and Elasticsearch. The chunk space 104 may support distributed processing architectures that enable parallel chunk generation, validation, and storage across multiple computational nodes.

The chunk space 104 may encompass collections containing varying scales of processed content to accommodate different application requirements and data volumes. For example, the chunk space 104 may contain at least 1,000 chunks, at least 100,000 chunks, at least 10 million chunks, at least 1 billion chunks, and/or at least 100 billion chunks, depending on the size and scope of the source document collection. Individual chunks within the chunk space 104 may be optimized for specific embedding models and may include content formatted according to model-specific requirements, tokenization schemes, vocabulary constraints, and/or input length limitations. The chunk space 104 may implement quality assurance mechanisms including duplicate detection, content validation, encoding verification, and/or semantic coherence assessment to ensure the integrity and usefulness of processed text segments.

The vector space 106 may encompass any representation of textual content as numerical vectors in a multi-dimensional coordinate system that enables computational analysis and similarity measurements. Embodiments of the vector space 106 may include any high-dimensional space where semantic relationships between textual elements are preserved through numerical encoding, allowing for efficient search, retrieval, and comparison operations. The vector space 106 may represent a computational framework that transforms human-readable text into machine-processable numerical formats while maintaining the underlying semantic meaning and contextual relationships present in the original content.

In some cases, the high-dimensional vector space 106 may include vectors with at least 128 dimensions, at least 256 dimensions, at least 512 dimensions, at least 768 dimensions, at least 1024 dimensions, at least 1536 dimensions, and/or at least 2048 dimensions. For example, many modern embedding models generate vectors in spaces with 768, 1024, or 1536 dimensions, though embodiments of the vector space 106 may utilize any suitable number of dimensions.

Embodiments of the vector space 106 may include various types of vector representations and embedding methodologies. For example, the vector space 106 may comprise dense vector embeddings generated by transformer-based models such as BERT, RoBERTa, GPT variants, T5, and/or specialized embedding models like Sentence-BERT. The vector space 106 may also include contextual embeddings that capture word meanings based on surrounding context, static embeddings that provide fixed representations for words and phrases, multilingual embeddings that support cross-language semantic search, and/or domain-specific embeddings trained on specialized corpora such as medical literature, legal documents, scientific papers, and/or technical documentation. In various embodiments, the vector space 106 may encompass fine-tuned embeddings customized for specific applications, pre-trained embeddings from general-purpose models, hybrid embeddings that combine multiple representation techniques, and/or adaptive embeddings that evolve based on usage patterns and feedback.

The vector space 106 may be characterized by specific dimensional properties and structures that determine the precision and computational requirements of semantic operations. In some cases, the vector space 106 may utilize variable-dimension embeddings that adapt size based on content complexity, fixed-dimension embeddings that maintain consistent vector lengths, compressed embeddings that reduce storage requirements through dimensionality reduction techniques, and/or expanded embeddings that increase dimensionality for enhanced semantic granularity. The vector space 106 may support various numerical precision formats including 32-bit floating point, 16-bit floating point, 8-bit quantized representations, and/or mixed-precision formats that balance accuracy with computational efficiency.

The vector space 106 may incorporate various organizational structures and indexing mechanisms that facilitate efficient search and retrieval operations. The vector space 106 may implement spatial partitioning techniques such as k-d trees, locality-sensitive hashing, random projection trees, and/or hierarchical navigable small world graphs that enable rapid nearest neighbor searches. In some cases, the vector space 106 may utilize clustering algorithms including k-means clustering, hierarchical clustering, DBSCAN, and/or Gaussian mixture models to organize similar vectors into coherent groups. The vector space 106 may employ distance metrics such as Euclidean distance, cosine similarity, Manhattan distance, Hamming distance, and/or custom similarity functions that quantify relationships between vector representations.

The vector space 106 may be implemented using various computational frameworks and storage technologies that optimize performance for large-scale vector operations. The vector space 106 may utilize specialized vector databases such as Pinecone, Weaviate, Qdrant, Milvus, and/or Chroma that provide optimized storage and retrieval capabilities for high-dimensional vectors. In some cases, the vector space 106 may employ general-purpose databases with vector extensions such as PostgreSQL with pgvector, Elasticsearch with dense vector support, Redis with vector similarity search, and/or MongoDB with vector search capabilities. The vector space 106 may implement distributed computing frameworks including Apache Spark with MLlib, TensorFlow with distributed training, PyTorch with distributed processing, and/or custom distributed systems that enable parallel vector operations across multiple computational nodes.

The vector space 106 may support various indexing strategies and optimization techniques that enhance search performance and accuracy. The vector space 106 may implement approximate nearest neighbor algorithms such as FAISS (Facebook AI Similarity Search), Annoy (Approximate Nearest Neighbors Oh Yeah), NMSLIB (Non-Metric Space Library), and/or ScaNN (Scalable Nearest Neighbors) that provide fast similarity searches with configurable accuracy trade-offs. The vector space 106 may utilize memory management techniques including vector caching, lazy loading, memory mapping, and/or compression algorithms that optimize resource utilization during search operations. In various embodiments, the vector space 106 may encompass real-time indexing capabilities that enable immediate availability of newly added vectors, batch indexing processes that optimize throughput for large-scale updates, incremental indexing that efficiently handles continuous data streams, and/or hybrid indexing approaches that combine multiple optimization strategies.

The vector space 106 may contain vector collections of varying scales and complexity levels to accommodate different application requirements and performance constraints. For example, the vector space 106 may encompass collections containing at least 1,000 vectors, at least 100,000 vectors, at least 1 million vectors, at least 10 million vectors, at least 1 billion vectors, and/or at least 100 billion vectors, depending on the scope of the semantic search application and available computational resources. Individual vectors within the vector space 106 may represent various granularities of textual content including individual words, phrases, sentences, paragraphs, document sections, complete documents, and/or collections of related documents. The vector space 106 may implement quality assurance mechanisms including vector validation, dimensionality verification, numerical stability checks, and/or semantic coherence assessment to ensure the integrity and usefulness of the embedded representations.

The vector space 106 may support various update and maintenance operations that ensure the continued accuracy and relevance of vector representations. The vector space 106 may implement versioning systems that track changes to vector representations over time, rollback mechanisms that enable recovery from problematic updates, synchronization protocols that maintain consistency across distributed deployments, and/or migration tools that facilitate transitions between different embedding models and vector formats. In some cases, the vector space 106 may include monitoring capabilities that track search performance metrics, usage patterns, accuracy measurements, and/or system resource utilization to enable optimization and troubleshooting of semantic search operations.

The index 108 may encompass any structural framework that establishes and maintains relationships between different components within the knowledge space 100, enabling efficient navigation and correlation across multiple data layers. Embodiments of the index 108 may include any systematic organization of references, pointers, and/or mapping structures that facilitate the retrieval and alignment of related information across the document space 102, chunk space 104, and vector space 106. The index 108 may represent a linking mechanism that preserves the contextual connections between original source materials, processed text segments, and their corresponding vector representations, thereby enabling seamless data traversal and retrieval operations.

Embodiments of the index 108 may include various categories of indexing structures and organizational frameworks. For example, the index 108 may comprise relational mapping systems that connect document identifiers to chunk identifiers and vector identifiers, hierarchical tree structures that organize content according to taxonomic classifications, graph-based networks that represent complex relationships between data elements, and/or associative arrays that provide direct lookup capabilities between related components. The index 108 may include temporal indexing systems that track chronological relationships, spatial indexing mechanisms that organize content according to geometric or topological properties, semantic indexing structures that group related concepts and themes, and/or hybrid indexing approaches that combine multiple organizational methodologies. In various embodiments, the index 108 may encompass cross-reference tables that maintain bidirectional relationships, inverted indexes that enable reverse lookups from vectors to source content, composite indexes that span multiple data dimensions, and/or distributed indexing systems that operate across multiple storage locations and computational nodes.

The index 108 may be characterized by specific implementation architectures and data management strategies that optimize performance for large-scale information retrieval operations. The index 108 may implement hash-based indexing systems that provide constant-time lookup operations, B-tree structures that maintain sorted order for range queries, bitmap indexes that enable efficient set operations, and/or bloom filters that provide probabilistic membership testing with minimal memory overhead. In some cases, the index 108 may utilize columnar storage formats that optimize access patterns for analytical queries, row-oriented structures that facilitate transactional operations, compressed indexing schemes that reduce storage requirements, and/or memory-mapped indexes that enable direct access to disk-based data structures. The index 108 may support various consistency models including eventual consistency for distributed systems, strong consistency for critical operations, and/or configurable consistency levels that balance performance with data integrity requirements.

The index 108 may incorporate various metadata management and versioning capabilities that ensure the accuracy and reliability of cross-component relationships. The index 108 may store creation timestamps, modification histories, access patterns, usage statistics, and/or quality metrics for each indexed relationship. In some cases, the index 108 may include provenance tracking that maintains detailed records of data lineage, audit trails that document all indexing operations, backup and recovery mechanisms that protect against data loss, and/or validation routines that verify the integrity of indexed relationships. The index 108 may implement conflict resolution strategies for handling concurrent updates, merge algorithms for combining distributed index updates, and/or synchronization protocols that maintain consistency across multiple index replicas.

The index 108 may support various query interfaces and access patterns that accommodate different application requirements and usage scenarios. The index 108 may provide key-value lookup operations for direct access to related components, range queries that retrieve sets of related items, pattern matching capabilities that support wildcard and regular expression searches, and/or full-text search functionality that enables content-based retrieval. In some cases, the index 108 may implement graph traversal algorithms that enable complex relationship queries, aggregation functions that compute summary statistics across indexed relationships, join operations that combine data from multiple index structures, and/or streaming interfaces that support real-time index updates and queries. The index 108 may utilize caching mechanisms including least-recently-used eviction policies, write-through caching for consistency, read-ahead prefetching for performance optimization, and/or distributed caching systems that span multiple computational nodes.

The index 108 may be implemented using various storage technologies and computational frameworks that optimize performance for different scales and access patterns. The index 108 may utilize in-memory data structures such as hash tables, red-black trees, skip lists, and/or trie structures for rapid access during interactive operations. In some cases, the index 108 may employ persistent storage solutions including relational databases with optimized indexing schemas, NoSQL databases such as Apache Cassandra and Amazon DynamoDB, search engines such as Apache Solr and Elasticsearch, and/or specialized indexing frameworks such as Apache Lucene and Sphinx. The index 108 may support distributed architectures that enable horizontal scaling across multiple servers, cloud-based implementations that leverage managed services, edge computing deployments that optimize for geographic distribution, and/or hybrid architectures that combine on-premises and cloud-based components.

The index 108 may encompass indexing structures of varying complexity and scale to accommodate different application requirements and data volumes. For example, the index 108 may contain at least 1,000 indexed relationships, at least 1 million indexed relationships, at least 1 billion indexed relationships, and/or at least 1 trillion indexed relationships, depending on the size and scope of the knowledge space 100. Individual index entries within the index 108 may include simple one-to-one mappings between components, one-to-many relationships that connect single documents to multiple chunks, many-to-many associations that represent complex interdependencies, and/or weighted relationships that quantify the strength of connections between components. The index 108 may implement compression techniques including dictionary encoding, run-length encoding, delta compression, and/or custom compression algorithms that reduce storage requirements while maintaining query performance.

The index 108 may support various maintenance and optimization operations that ensure continued performance and accuracy as the knowledge space 100 evolves. The index 108 may implement automatic rebalancing algorithms that optimize index structure based on access patterns, garbage collection routines that remove obsolete index entries, defragmentation processes that optimize storage layout, and/or statistics collection mechanisms that inform query optimization decisions. In some cases, the index 108 may include adaptive indexing strategies that automatically adjust index structures based on workload characteristics, machine learning algorithms that predict optimal index configurations, performance monitoring systems that track query response times and resource utilization, and/or automated tuning capabilities that optimize index parameters based on observed performance metrics.

The cluster space 202 may encompass any organized representation of high-dimensional vector data that has been partitioned into distinct groups based on similarity characteristics, enabling efficient search and retrieval operations within semantic search systems. Embodiments of the cluster space 202 may include any systematic arrangement of vector clusters that reduces computational complexity while preserving semantic relationships between data points. The cluster space 202 may represent a structured framework that transforms dense, high-dimensional vector spaces into manageable subdivisions, thereby facilitating rapid identification of relevant data regions during query processing operations.

Embodiments of the cluster space 202 may include various clustering methodologies and organizational approaches that optimize search performance across different application domains. For example, the cluster space 202 may comprise k-means clustering implementations that partition vectors based on centroid proximity, hierarchical clustering structures that organize data in tree-like arrangements, density-based clustering systems such as DBSCAN that identify clusters based on point density, and/or spectral clustering approaches that utilize eigenvalue decomposition for cluster identification. The cluster space 202 may include Gaussian mixture model clustering that assumes probabilistic distributions, agglomerative clustering that builds clusters through iterative merging, divisive clustering that recursively splits data into smaller groups, and/or fuzzy clustering implementations that allow partial membership in multiple clusters. In various embodiments, the cluster space 202 may encompass stochastic clustering methods that incorporate randomization for improved performance, deterministic clustering approaches that produce consistent results, adaptive clustering systems that adjust cluster boundaries based on data characteristics, and/or ensemble clustering techniques that combine multiple clustering algorithms.

The cluster space 202 may be characterized by specific structural configurations and properties that determine clustering effectiveness and computational efficiency. The cluster space 202 may implement fixed-size clusters that maintain consistent membership counts, variable-size clusters that adapt to data density variations, overlapping clusters that allow shared membership between adjacent groups, and/or non-overlapping clusters that enforce strict boundary separation. In some cases, the cluster space 202 may utilize spherical clusters that assume circular or hyperspherical boundaries, elliptical clusters that accommodate elongated data distributions, irregular clusters that conform to complex data shapes, and/or convex clusters that maintain convexity properties. The cluster space 202 may support various distance metrics including Euclidean distance for geometric clustering, Manhattan distance for grid-based partitioning, cosine similarity for angular relationships, and/or custom distance functions tailored to specific data characteristics.

The cluster space 202 may support various cluster representation formats and storage mechanisms that facilitate efficient access and manipulation during search operations. The cluster space 202 may store cluster centroids as representative points that summarize cluster characteristics, cluster boundaries as geometric or mathematical constraints that define membership regions, cluster membership lists that enumerate constituent data points, and/or cluster metadata that includes statistical properties and quality metrics. In some cases, the cluster space 202 may implement compressed cluster representations that reduce storage requirements, distributed cluster storage that spans multiple computational nodes, cached cluster data that optimizes access performance, and/or indexed cluster structures that enable rapid cluster identification and retrieval.

The cluster space 202 may encompass clustering configurations of varying scales and complexity levels to accommodate different vector space sizes and application requirements. For example, the cluster space 202 may contain at least 10 clusters, at least 100 clusters, at least 1,000 clusters, at least 10,000 clusters, and/or at least 100,000 clusters, depending on the size of the underlying vector space 106 and the desired granularity of data organization. Individual clusters within the cluster space 202 may contain at least 10 data points, at least 100 data points, at least 1,000 data points, at least 10,000 data points, and/or at least 100,000 data points, with cluster sizes potentially varying based on data density and distribution characteristics. The cluster space 202 may implement cluster size balancing algorithms that maintain relatively uniform cluster populations, adaptive sizing mechanisms that adjust cluster boundaries based on data characteristics, and/or hierarchical cluster structures that nest smaller clusters within larger organizational units.

The cluster space 202 may implement various dynamic updating and maintenance capabilities that ensure continued clustering effectiveness as the underlying vector space 106 evolves. The cluster space 202 may support incremental clustering updates that incorporate new data points without complete reclustering, batch reclustering operations that periodically optimize cluster boundaries, online clustering algorithms that adapt to streaming data, and/or hybrid updating approaches that combine multiple maintenance strategies. In some cases, the cluster space 202 may include cluster splitting mechanisms that divide oversized clusters, cluster merging operations that combine similar adjacent clusters, cluster deletion processes that remove obsolete or empty clusters, and/or cluster migration tools that facilitate transitions between different clustering algorithms or parameters.

While the disclosure herein describes K-Nearest Neighbor (KNN) search as the primary method for identifying relevant data points within clusters, embodiments of the present invention may utilize various alternative search methodologies to achieve the same functional objectives. The KNN search approach described herein represents one example implementation among many possible search strategies that may be employed within the clustering framework. The selection of a particular search methodology may depend on factors such as computational resources, accuracy requirements, data characteristics, and performance constraints specific to different application contexts.

Embodiments of the present invention may implement distance-based search alternatives that provide direct computation of similarity measurements between the prompt embedding 505 and data points within each cluster. For example, brute-force distance calculations may compute Euclidean distances between the prompt embedding 505 and every data point within the current cluster, providing exact distance measurements without approximation. Range queries may identify all data points within a specified distance threshold from the prompt embedding 505, enabling retrieval of all relevant points below a predetermined similarity cutoff. Threshold-based searches may retrieve points that fall within configurable distance boundaries, allowing for adaptive search scope based on cluster characteristics and query requirements. In some cases, exhaustive search methods may examine all data points within a cluster to ensure comprehensive coverage, particularly in applications where accuracy takes precedence over computational efficiency.

Referring to FIG. 5, tree-based search structures may be implemented within the sequential cluster search module 510 to organize data points in hierarchical arrangements that facilitate efficient similarity identification. K-d trees may partition the high-dimensional space within each cluster using recursive binary splits along different dimensions, enabling logarithmic search complexity for nearest neighbor identification. Ball trees may organize data points within hyperspheres that minimize the maximum distance between any point and the sphere center, providing efficient search capabilities in high-dimensional spaces where k-d trees may become less effective. R-trees may utilize rectangular bounding boxes to organize spatial data, enabling efficient range queries and nearest neighbor searches within geometric constraints. Quad-trees and octrees may provide hierarchical space partitioning that recursively subdivides clusters into smaller regions, facilitating rapid elimination of irrelevant data points during search operations.

Hash-based search approaches may be employed by embodiments of the present invention to provide approximate similarity search with reduced computational overhead compared to exact methods. Locality-sensitive hashing may map similar data points to the same hash buckets with high probability, enabling rapid identification of candidate nearest neighbors through hash table lookups rather than exhaustive distance calculations. Random projection methods may preserve distance relationships while reducing dimensionality, allowing for efficient similarity search in lower-dimensional projected spaces. MinHash techniques may estimate similarity between data points through probabilistic sampling, providing approximate nearest neighbor identification with configurable accuracy trade-offs. In various embodiments, consistent hashing approaches may distribute data points across hash buckets in a manner that preserves locality relationships, enabling efficient retrieval of similar points through hash-based indexing structures.

With continued reference to FIG. 5, graph-based search methodologies may be integrated into the KNN search sub-module 512 to leverage network structures for efficient similarity identification. Hierarchical navigable small world graphs may organize data points in multi-layer network structures that enable logarithmic search complexity through greedy routing algorithms. Proximity graphs may connect each data point to its nearest neighbors, creating network structures that facilitate efficient traversal from the prompt embedding 505 to similar data points through edge-following algorithms. Navigable small world networks may balance local connectivity with long-range connections, enabling efficient search through small-world properties that reduce average path lengths between data points. Graph-based approaches may utilize various distance metrics including Euclidean distance, cosine similarity, and custom similarity functions to define edge weights and connectivity patterns within the network structure.

Embodiments of the present invention may implement approximate search algorithms that provide near-optimal results with significantly reduced computational requirements compared to exact search methods. Product quantization methods may compress high-dimensional vectors into compact representations while preserving similarity relationships, enabling efficient storage and rapid similarity computation through quantized distance calculations. Inverted file systems may index quantized vectors in structures similar to text search engines, providing fast retrieval of candidate nearest neighbors through inverted index lookups. Randomized algorithms may utilize probabilistic sampling and random projections to identify approximate nearest neighbors with configurable accuracy guarantees. Sketching techniques may create compact summaries of data point characteristics that enable rapid similarity estimation without full vector comparisons.

As further shown in FIG. 5, the calculated distances 513 generated by alternative search methodologies may maintain the same functional interface with the data point selection sub-module 514, ensuring compatibility with the overall system architecture regardless of the specific search approach employed. Multi-modal search strategies may combine multiple search methodologies within a single implementation, utilizing different approaches for different types of queries or cluster characteristics. Adaptive search selection may dynamically choose the most appropriate search method based on cluster size, dimensionality, data distribution, and performance requirements. Hybrid search approaches may combine exact and approximate methods, using fast approximate searches for initial candidate identification followed by exact distance calculations for final ranking and selection.

The clustering-based optimization framework described herein may accommodate any of these alternative search methodologies while maintaining the core advantages of reduced computational complexity and improved accuracy through distance range limitation. The choice of search methodology may be configured based on specific application requirements, with some embodiments prioritizing speed through approximate methods while others emphasize accuracy through exact search approaches. The modular architecture of embodiments of the present invention may enable runtime selection of search strategies, allowing systems to adapt their search methodology based on changing performance requirements, data characteristics, and computational resource availability.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, the use of stochastic k-means clustering by embodiments of the present invention to organize a high-dimensional vector space into manageable clusters is a process that requires the computational power and speed of modern processors. This clustering process involves complex mathematical calculations and the handling of large datasets that are beyond human cognitive capabilities and would be unfeasible to perform manually.

Additionally, the application of the K-Nearest Neighbor (KNN) algorithm by embodiments of the present invention, particularly using the FAISS library for efficient similarity search within these clusters, is necessarily rooted in computer technology. This feature leverages specialized algorithms and hardware acceleration (such as GPUs) to perform rapid distance calculations and retrieval operations across potentially billions of data points, a task that is impossible without the aid of computer technology.

Moreover, embodiments of the present invention improve computer technology by enhancing the efficiency and accuracy of semantic searches in large language models. It introduces an optimized method for determining semantic relevance using Euclidean distance in dense vector spaces, which is a significant improvement over existing methods that primarily rely on cosine similarity. This not only addresses the computational challenges associated with high-dimensional data but also improves the precision of search results, thereby enhancing the overall functionality and performance of retrieval systems in AI applications.

These features, both individually and collectively, constitute an improvement to computer technology, specifically in the fields of data retrieval and machine learning, by enabling more efficient processing, better resource management, and more accurate data handling capabilities than previously possible.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A computer-implemented method for semantic search optimization in high-dimensional vector spaces, the method comprising:
(A) receiving a user query;
(B) generating a prompt embedding from the user query, wherein the prompt embedding comprises a numerical vector in a high-dimensional vector space;
(C) determining Euclidean distances between the prompt embedding and a plurality of cluster centers in the high-dimensional vector space, wherein each cluster center represents a cluster of data points;
(D) identifying a jump point as the cluster center having the shortest Euclidean distance to the prompt embedding;
(E) performing a sequential cluster search starting from the jump point and proceeding in ascending order of Euclidean distance from the prompt embedding, the sequential cluster search comprising, for each cluster searched:
(E)(1) performing a K-Nearest Neighbor (KNN) search within the cluster to determine Euclidean distances between the prompt embedding and data points within the cluster;
(E)(2) selecting a set of top data points having the shortest Euclidean distances to the prompt embedding; and
(E)(3) computing semantic relevance scores for the selected top data points using a relevance function based on the determined Euclidean distances.

2. The method of claim 1, wherein (C) comprises determining a number of clusters in the high-dimensional vector space based on a square root of a total number of data points in the vector space.

3. The method of claim 1, wherein (C) comprises determining a number of clusters in the high-dimensional vector space, and wherein determining the number of clusters in the high-dimensional vector space comprises:
analyzing vector space density characteristics;
evaluating embedding distribution patterns; and
dynamically adjusting the number of clusters based on real-time performance metrics.

4. The method of claim 1, wherein:
calculating the Euclidean distances between the prompt embedding and each cluster center utilizes a first distance metric; and
computing the semantic relevance scores employs a second, different, distance metric.

5. The method of claim 1, wherein performing the search for data points is performed within a maximum of 10 milliseconds for 1 million samples.

6. The method of claim 5, wherein the search for data points processes at least 100,000 data points.

7. The method of claim 1, wherein using the KNN search algorithm comprises using an optimized similarity search library for enhanced performance.

8. The method of claim 1, wherein computing the semantic relevance scores comprises:
calculating a first boundary point B1=μ1+ασ1, where μ1 and σ1 represent a mean and standard deviation of a distribution of distances between each prompt embedding, including the prompt embedding generated from the user query, and its nearest neighbor in the high-dimensional vector space; and
calculating a second boundary point B2=μ2−βσ2, where μ2 and σ2 represent a mean and standard deviation of a distribution of all pairwise distances between prompt embeddings in the high-dimensional vector space.

9. The method of claim 8, wherein the method further comprises calibrating the constants α and β using a test set to ensure that unrelated prompts yield a relevance of 0, while highly relevant prompts yield a relevance of 1.

10. The method of claim 1, wherein the high-dimensional vector space comprises at least one hundred thousand embeddings.

11. The method of claim 1, wherein the prompt embedding has at least 768 dimensions.

12. The method of claim 1, further comprising:
identifying relevant data points within a specified distance threshold based on the computed semantic relevance scores; and
fetching the identified relevant data points.

13. The method of claim 1, further comprising inserting the selected set of top data points having the shortest Euclidean distances to the prompt embedding as relevant context from the high-dimensional vector space into a prompt for a large language model, and wherein the relevant context is based on the computed semantic relevance scores.

14. The method of claim 1, wherein:
calculating Euclidean distances between the prompt embedding and the plurality of cluster centers comprises implementing distributed cluster processing by simultaneously calculating the Euclidean distances for different subsets of cluster centers across multiple computational nodes; and
performing the sequential cluster search comprises processing different clusters simultaneously across the multiple computational nodes.

15. A system for semantic search optimization in high-dimensional vector spaces, the system comprising:
a memory component configured to store a database of data points organized into clusters in a high-dimensional vector space;
a processor component configured to generate a prompt embedding from a user query, wherein the prompt embedding comprises a numerical vector in the high-dimensional vector space;
a distance calculation module configured to determine Euclidean distances between vectors in the high-dimensional vector space;
a clustering module configured to organize the data points into clusters, wherein each cluster center represents a cluster of data points;
a search engine configured to perform K-Nearest Neighbor (KNN) searches within clusters; and
a relevance scoring module configured to compute semantic relevance scores using a relevance function based on the determined Euclidean distances;
wherein the processor component is further configured to:
identify a jump point as the cluster center having the shortest Euclidean distance to the prompt embedding;
perform a sequential cluster search starting from the jump point and proceeding in ascending order of Euclidean distance from the prompt embedding;
for each cluster searched, utilize the search engine to perform a KNN search within the cluster to determine Euclidean distances between the prompt embedding and data points within the cluster;
select a set of top data points having the shortest Euclidean distances to the prompt embedding; and
utilize the relevance calculator to compute semantic relevance scores for the selected top data points.

16. The system of claim 15, wherein the distance calculation module is configured to determine a number of clusters in the high-dimensional vector space, and wherein determining the number of clusters in the high-dimensional vector space comprises:
analyzing vector space density characteristics;
evaluating embedding distribution patterns; and
dynamically adjusting the number of clusters based on real-time performance metrics.

17. The system of claim 15, wherein:
calculating the Euclidean distances between the prompt embedding and each cluster center utilizes a first distance metric; and
computing the semantic relevance scores employs a second, different, distance metric.

18. The system of claim 15, wherein computing the semantic relevance scores comprises:
calculating a first boundary point B1=μ1+ασ1, where μ1 and σ1 represent a mean and standard deviation of a distribution of distances between each prompt embedding, including the prompt embedding generated from the user query, and its nearest neighbor in the high-dimensional vector space; and
calculating a second boundary point B2=μ2−βσ2, where μ2 and σ2 represent a mean and standard deviation of a distribution of all pairwise distances between prompt embeddings in the high-dimensional vector space.

19. The system of claim 18, wherein the method further comprises calibrating the constants α and β using a test set to ensure that unrelated prompts yield a relevance of 0, while highly relevant prompts yield a relevance of 1.

20. The system of claim 15, wherein the processor component is further configured to:
identify relevant data points within a specified distance threshold based on the computed semantic relevance scores; and
fetch the identified relevant data points.
